(19) United States
(12) Patent Application Publication
(10) Pub. No.: US 2003/0074324 A1
(43) Pub. Date: Apr. 17, 2003

(54) Apparatus and method for providing postal services

(76) Inventors: Roman P. Kresina, Oxford, CT (US); Joseph D. Busch, Trumbull, CT (US); Daniel P. Fearnley, Stratford, CT (US)

Correspondence Address: PERMAN & GREEN, 425 POST ROAD, FAIRFIELD, CT, 06824, US

(21) Appl. No.: 09/781,689

(22) Filed: Feb. 12, 2001

Related U.S. Application Data
(60) Provisional application No. 60/181,757, filed on Feb. 11, 2000.

(51) Int. Cl. G06F 17/60

(52) U.S. Cl. 705/60

(57) ABSTRACT

A system and method for providing postal services to a plurality of remote postal printing stations includes a communications facility for conducting communications between and a number of services provided by the system to the remote stations when the remote stations access the system. The services include at least one of key management, funds telemetering, software updating, postal rate updating, address cleansing, account management, and recording postal statistics. The communications facility may include an interface for Internet communication and an interface for modem communication. The interface for internet communication may include a remote access server and a plurality of application programming interfaces. A monitor may be provided for determining when any service is being accessed, to provide a signal to all other services that additional services can be provided to the remote station.

This application claims priority from provisional patent application serial No. 60/181,757 filed on Feb. 11, 2000.

### BACKGROUND OF THE INVENTION

1. Field of the Invention

The present invention relates to apparatus and methods useful for providing postage metering services. More particularly, it relates to a system and method wherein a remote user can have access to a central infrastructure to take advantage of the services provided by that infrastructure.

2. Background Art

The United States Postal Service has proposed an Information-Based Indicia Program (IBIP) to allow postage indicia to be printed in so called open systems by using, for example, a personal computer, and printer, or a small office mailing system. While this approach has a great deal of appeal in that relatively simple and low cost equipment can be used at a customer site, it would be even more advantageous if a broad range of services could be made available to the users of such equipment. For example, services such as software updates, postage rate updates, secure transfer of funds and other important services would make such open systems, and closed systems as well, even more desirable.

### SUMMARY OF THE INVENTION

It is an object of the invention to provide a system that has multifunction capability in making a variety of services available to a postal customer.

It is another object of the invention to provide an infrastructure that makes such services available.

It is a further object of the invention to provide a method for using conventional communications protocols to make such services available.

The invention is directed to a system and method for providing postal services to a plurality of remote postal printing stations. The system includes a communications facility for conducting communications between a number of services provided by the system to the remote stations when the remote stations access the system using communications facility. The services include at least one of key management, funds telemetering, software updating, postal rate updating, address cleansing, account management, and recording postal statistics. The communications facility may include an interface for Internet communication and an interface for modem communication. The interface for Internet communication may include a remote access server and a plurality of application programming interfaces. A monitor may be provided for determining when any service is being accessed, to providing a signal to all other services that additional services can be provided to the remote station. This monitor may be located in each remote station. Data encryption facilities may be used, with a different level of security being provided by said facilities for different ones of said services.

### BRIEF DESCRIPTION OF THE DRAWINGS

The foregoing aspects and other features of the present invention are explained in the following description, taken in connection with the accompanying drawings, wherein:

FIG. 1 is a block diagram of a system in accordance with the invention.

FIG. 2 is a simplified and more general block diagram of a system in accordance with the invention.

FIG. 3 is a simplified diagram of an Internet communications protocol used in the system of FIG. 1 and FIG. 2.

FIG. 4 is a diagram illustrating the relationship between various communications classes used in the protocol illustrated in FIG. 3.

FIG. 5 illustrated a typical data flow between a user and a front-end server of the system of FIG. 1 and FIG. 2.

FIG. 6 illustrates the class of communications on the services router of the system of FIG. 1 and FIG. 2.

FIG. 7 is a flow diagram which illustrates the normal flow of messages as they arrive from the client and are sent to the server, and messages as they arrive from the server and are sent to the client.

### DETAILED DESCRIPTION OF THE PREFERRED EMBODIMENT

Definitions, Acronyms, Abbreviations

The following is a list of common terms used throughout this document:

| Name | Abbreviation | Definition |
|---|---|---|
| Cryptographic | | Of or relating to codes that |
| | | convert data so that only a |
| | | specific recipient will be able to |
| | | read it using a key; also can |
| | | refer to public encryption in |
| | | which you need a specific key to |
| | | encode the data, but the key to |
| | | decode the data is widely |
| | | available. |
| Digital | | A personal authentication method |
| Signature | | based on encryption and secret |
| | | authorization codes used for |
| | | signing electronic documents. |
| Digital | DSA | An encryption algorithm based on |
| Signature | | the Digital Signature Standard; |
| Algorithm | | see FIPS PUB 186. |
| Facing | FIM | A pattern of vertical bars printed |
| Identification | | in the upper right portion of the |
| Mark | | mailpiece just to the left of the |
| | | Indicium, used to identify |
| | | business reply mail and certain |
| | | barcoded mail. The FIM is an |
| | | orientation mark for automated |
| | | facing and canceling equipment. |
| Indicia/ | | The imprinted designations used on |
| Indicium | | mailpieces denoting method of |
| | | postage payment. |
| Information- | IBI/IBIP | A program to support new methods |
| Based Indicia | | of applying postage in lieu of the |
| Program | | current approach that typically |
| | | relies on a postage meter |
| | | mechanically printing the Indicium |
| | | on mailpieces. In general, these |
| | | new methods will involve the use |
| | | of a computer and printer to |
| | | create and print indicia on |
| | | mailpieces and envelopes. |
| Key | KMS | A system that is part of the |
| Management | | infrastructure. This system is |
| System | | responsible for managing the |
| | | security aspects of the PC-Meter |
| | | product. It deals with the |
| | | cryptographic aspects related to |
| | | the PSD. |
| PDF417 | | A stacked 2-D barcode symbology |
| | | developed by Symbol Technologies, |
| | | Inc. |
| Postal | PSD | The device that provides security- |
| Security | | critical functions for IBIP |
| Device | | customers. |
| Private key | | One of two keys used in the |
| | | digital signature; the private is |
| | | not shared and is used to create |
| | | the digital signature. |
| Tele Meter | TMS | A system that is part of the |
| Setting ® | | infrastructure which is |
| | | responsible for downloading of |
| | | funds to electronic postage |
| | | meters. On the PC-Meter product |
| | | it is used to download funds to |
| | | the PSD. |

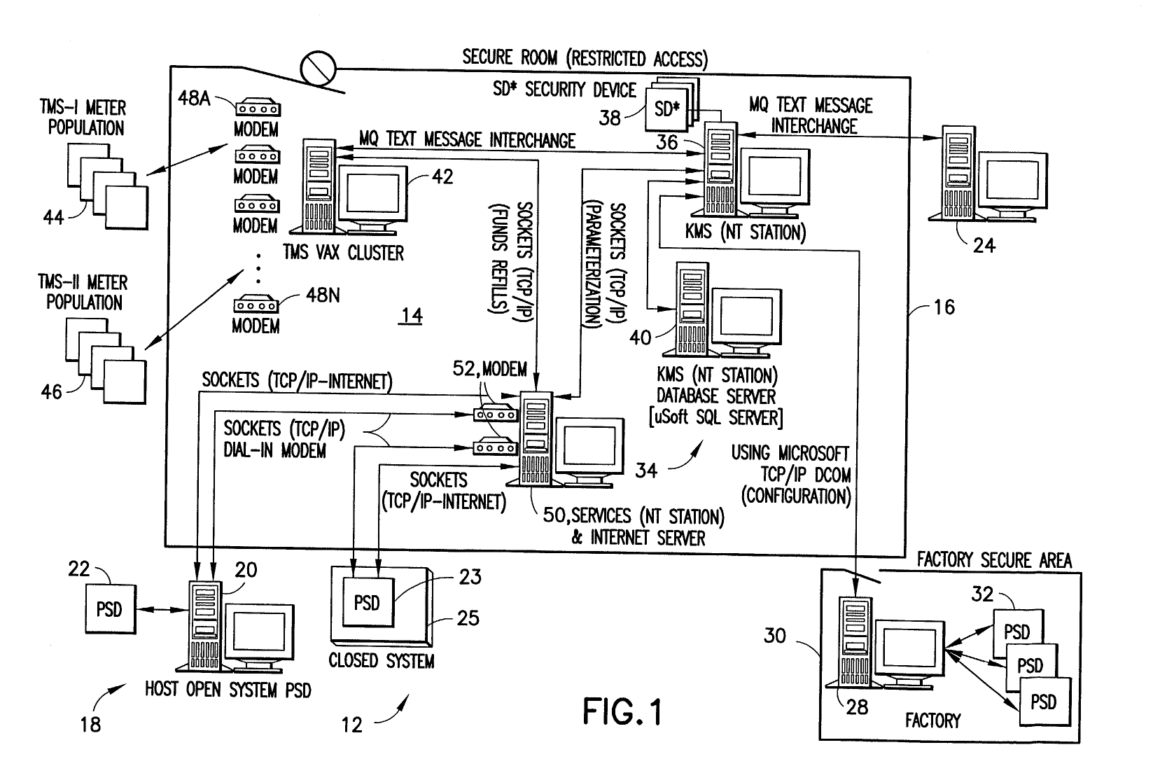

Referring to FIG. 1, there is shown a block diagram of a system 12 incorporating features of the present invention. Although the present invention will be described with reference to the embodiments shown in the drawings, it should be understood that the present invention can be embodied in many alternate forms of embodiments. In addition, any suitable type of elements or materials could be used.

System 12 includes a postal system infrastructure 14 which is preferably housed in a secure location or room 16 which only authorized personnel may enter. As more fully described below, infrastructure 14 communicates with a plurality of postage printing host systems 18, which may be of the open system variety, including a personal computer 20 and an appropriate Postal Security Device (PSD) 22 for securely storing the value of funds to be expended when postage is printed. Infrastructure 14 may also communicate with a plurality of PSD's, as represented by PSD 23 of a number of so called closed systems 25, as more fully described below. Infrastructure 14 may also communicate with a data processing system 24, such as for example an IBM AS 400 system to handle data processing needs. Through this system the customer can place orders for new PSD(s), return PSD(s) no longer needed and report lost or stolen PSD(s). The system will also track PSDs through its life cycle. While data processing system 24 is shown as being external to room 16, it will be understood that there is nothing to prevent it from being located therein. A connection may also be made between infrastructure 14 and a factory production computer system 28 in a factory secure area of room 30 so that functions such as PSD encryption and key management can be carried out when new PSD's 32 are produced, or when they are serviced in a factory setting.

Infrastructure 14 may include, among other service providing systems a key management system 34 in including a Key Management System Station (such as an NT station) 36, which includes a plurality of security devices (SD)38 as well as a database server 40. Infrastructure 14 may also include a TMS system 42 for interfacing with a plurality of postage printing stations 44 and 46 of various kinds by a bank of conventional modems 48A to 48N. Also illustrated in FIG. 1 is services and Internet server 50 that communicates with a number of stations 20 and 25 by using TCP/IP Internet protocol sockets on the Internet or by using modems 52, and preferably the same protocol as more fully explained below.

Data access, via external local area or wide area networks, is protected and restricted by means of encryption, digitally signed data and a firewall. The host or remote station 10 and PSD systems are located at a customers' facilities. Access to these systems are restricted according to the needs of each customer.

The primary function of the server 50 of FIG. 1 is to act as a router between the Postal Security Devices, connecting in from customer sites, and the TMS system 42 and KMS system 34. Physical connection to the server 50 is made either via a dial-up modem or via the Internet. In either case, the connection is made through a specific TCP/IP address and socket port number. There are two port numbers available for connection. Depending upon which port is specified, the server 50 will establish a virtual connection between the PSD and either the TMS System or the KMS System. Once the virtual connection is established, data may be transmitted back and forth until the virtual connection is broken. It is not necessary to re-establish a physical connection in order to establish a virtual connection to the other system. Once a physical connection is established, one or more virtual connections may be simultaneously established with the TMS, KMS or both systems concurrently. A server 50 may be used to encrypt and decrypt data being transferred between infrastructure systems and the host systems.

The primary function of the Key Management System 34 is to provide software that will manage the usage of public and private keys for the Postal Security Device. Additionally, KMS 34 will provide all of the ancillary services to the PSD while it is in the manufacturing facility, including the manufacture, configuration, the removal from service and the reinstatement to service for a new customer. KMS deals with a few external interfaces. They include the server 50, the PSD (via the Ascom Host System), the USPS Certificate Authority, the Tele-Metering System (TMS), and the Order Processing and Meter Tracking System or data processing system 24.

KMS manages the keys and certificates that are stored in the PSD and in the Ascom KMS database. KMS is responsible to emulate the current “Check In/Check Out” process of the USPS. Additionally, KMS acts as the main tool to diagnosis problems that may occur in the PSD while it is in the field. The diagnostic capability allows technicians the ability to view the PSD's log files discussed below.

The primary function of the TMS system 34 is to manage customer funds and audit information concerning the use of the funds. The TMS System is given the identity and encryption key of a PSD during the manufacturing process. When the PSD is assigned to a customer, the correlation between the PSD and customer account number is created. From then on, any time funds are to be loaded into the PSD, it is the TMS's responsibility to insure they are taken from the correct customer account. Each time funds are loaded into the PSD, the PSD returns audit information back to the TMS. The TMS verifies and stores this information under the appropriate customer's account. When a customer's PSD is returned for repair or surrender, the TMS sends the PSD's control total data to the KMS System.

The Host system or remote stations include a client/server software product that provides the capability to print addresses and indicium on mail pieces. The client side components provide the addressing application while the server side components provide the indicia generation. The Host System utilizes one or more standard personal computer(s) with printers. The PC(s) may have attached one or more physical Postal Security Device(s) (PSD) through serial ports. The combination of PC(s), printers and PSD(s) may be distributed over local (LAN) or wide area (WAN) networks.

The server portion of the product may to be incorporated into third party products or used as an embedded control for Microsoft's Office products in order to provide address cleansing and indicia generation.

The product performs IBIP printing in addition to the functions of address list selection, cleansing of addresses and finally printing of the addresses.

The software also manages all of the communications between the PSD and the infrastructure; namely, the TMS 42 and Key Management System (KMS) 34 for the purposes of postage refills, parameterization, encryption key generation, or software updates.

The Postal Security Device product is a specific implementation of the USPS-defined IBIP (Information Based Indicia Program) technology. The PSD is a secure device that is attached to the host system via an RS-232 serial port. It contains funds that are used to frank mailpieces. The funds are securely added to the PSD by connecting to the TMS System. The TMS System downloads the funds, via the host System or remote station software, to the PSD. The PSD subsequently uploads audit information back to the TMS. Once the PSD has funds available, it is able to generate Indicia Data for evidencing postage payment including computation of any cryptographic data. During its life cycle the PSD maintains accurate postal accounting registers and transaction history.

The PSD also communicates to the KMS System via the host system software. The PSD and KMS cooperate to generate the indicia by insuring that an active indicia certificate exists for the PSD. The PSD can get new keys when the keys or certificates are about to expire via calling into the KMS System. The KMS System may also used for the parameterization and authorization of the PSD while the device is in the field.

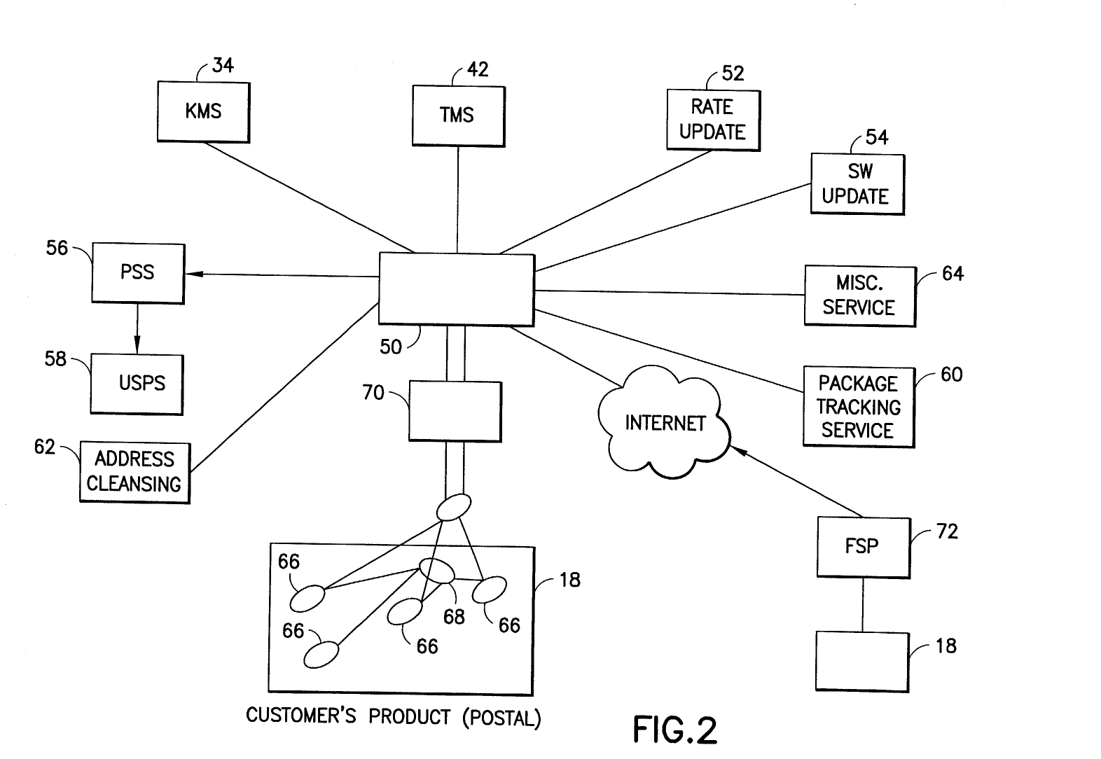

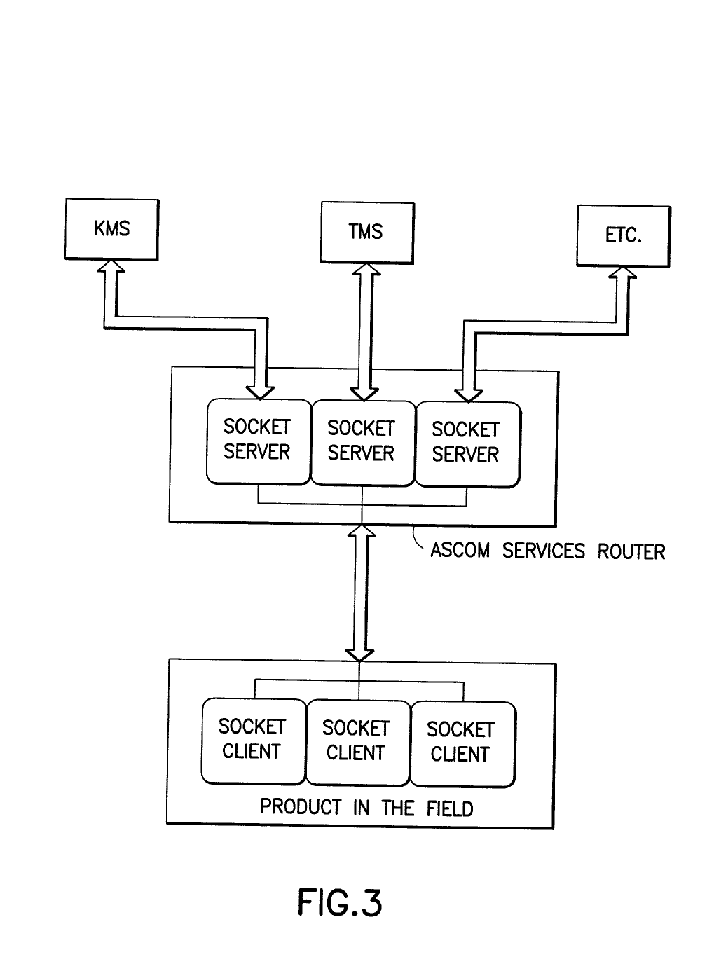

FIG. 2 illustrates a simplified and generalized system in accordance with FIG. 1 which may utilize the communication protocol of FIG. 3. It is meant to conceptually illustrate a system supplying services broadly. FIG. 2 uses the same reference numerals as FIG. 1 for elements already described with respect to FIG. 1, which description will not be repeated. However, additional elements are described below.

Other services that may be provided are those from a postal rate update system 52, a host software update system 54, and a postal statistics server or PSS 56. The later may be used to upload postal log data. As more fully described below. This data can then be sent to the United States Postal Service 58 by modem over via the Internet.

Other services may include a package tracking application or service system 60. Individuals or business awaiting a package shipped with postage or the indicia of other services entered at hosts or remote locations 1.8, may determine the time and date on which a package was shipped, if provided with the proper software and passwords needed to communicate with infrastructure 14.

A central address cleansing system 62 may provide address cleansing for addresses entered at remote stations 18. Finally, a miscellaneous service system 64 may be used to provide any one of a number of different services not necessary tied into postal functions. For example, this system may be used to enable printing of tickets to entertainment events, with a PSD like security feature, so that payment is verified before a ticket is printed. Alternatively, it may be used to print lottery tickets. Thus, remote stations 18 can be used for a variety of functions, limited only by infrastructure 14 and appropriate software being available in each host or remote station 18.

With regard to the software in each host or remote station 18, each one is represented by a module 66, which will have a corresponding socket, as described below. A separate software module, in the form of a monitor module 68, checks for operation of any of the other modules 68. If a connection is made to the infrastructure to obtain any service, module 68 provides an appropriate signal to the other modules 66 to notify the other modules that a connection has been made, and to give these other modules an opportunity to receive corresponding services from the appropriate system in infrastructure 14.

As shown in FIG. 2, each host or remote station is connected to infrastructure 14 by means of a modem 70, or via the Internet by means of an ISP 72 as more fully discussed below.

Referring to FIG. 3 the session layer communications protocol between a remote station and the infrastructure 14 is described. The infrastructure provides a standardized backbone of communications to current systems as well as any future systems.

All communications to the infrastructure 14 takes place via the TCP/IP protocol. The physical connection may be a direct telephone connection or via the Internet through some internet service provider (ISP).

The TCP/IP protocol is an industry standard, which allows multiple concurrent connections allowing a connected system to communicate with multiple entities within the infrastructure. Each entity within the infrastructure may have a different application level protocol but all will utilize the same session layer protocol.

As illustrated in FIG. 3, the Sockets API is used to access the functionality of TCP/IP. Therefore, the remainder of this document is written from that standpoint. It is also assumed that the Sockets API will be provided by the Operating System.

The infrastructure contains one main connection entity called s services router. This router is comprised of multiple Socket Servers, where each Socket Server is accepting connections on a particular Socket Port. Each Socket Port is representative of some service such as the TMS or KMS. The router then routes these service connections to the individual entities within the Infrastructure (e.g. TMS, KMS).

FIG. 3 depicts the connections between a product and the Ascom Services Infrastructure.

The product side of the connection is always a Socket Client. For each Service that is to be connected, one must create a Socket Client connection to each Service. Since all of the Services are routed through one Service Router, only one IP address is necessary and while the Socket Port number distinguishes each service. If for example, the product was to connect to the TMS and KMS, it would connect to the two different Socket Port numbers representing those two entities.

The Socket Clients (product side) establish connections by connecting to the Socket Server (Services Router). There is no Session layer logon; rather any logon is left to the application layer protocol. This accommodates the nuances of each service.

Since Sockets represent a stream of data, one must be able to distinguish the start and end of a “real” message. To do this, the session layer uses a Transmission header that describes the data. The Transmission header is always sent before the actual data. The data may be encrypted or non-encrypted, this is indicated by a flag in the header It is up to the application layer to indicate whether the data should be encrypted before transmission. The receiving side will examine the encryption flag in the Transmission header and decrypt the data if need be.

The following structure describes the Transmission header:

typedef struct TransmissionHeader_t
{

| | |
|---|---|
| ULONG Cookie; | //Must be loaded |

with COOKIE

| | |
|---|---|
| ULONG ProtocolID; | //ID of protocol |

being used

| | |
|---|---|
| ULONG ProtocolVersion; | //Version of |

Protocol being used

| | |
|---|---|
| ULONG MessageSize; | //Size of message |

following header

| | |
|---|---|
| ULONG FlagBits; | //Bit flags... |

see below for definitions

| | |
|---|---|
| ULONG Spare; | |
| ULONG Cookie1; | //Must be loaded with |

COOKIE1

}TransmissionHeader;
//Flag bits mask definitions
#define DATA_ENCRYPTED 0×00000001
//Cookie definitions
const ULONG COOKIE = 0×3456789a;
const ULONG COOKIE1 = 0×12345678;
//Protocol IDs and versions

| | |
|---|---|
| const ULONG MESSAGE_PIPE_PROTOCOL = 1; | //ID of Message |

| | |
|---|---|
| Pipe Protocol | |
| const ULONG V1_MPP = 1; | //Version |
| one of Message Pipe Protocol | |

When receiving a message the following must be done:

1. Receive the Transmission Header. The streaming Socket protocol is such that transmission may be broken up at the will of the Socket layer. For example, if a “send” is posted for 100 bytes, the call may come back to the requesting code with the indication that only 37 bytes were sent. The requesting code must then make another request to send the rest of the 63 bytes and repeat the procedure if necessary. The same is true for receiving side; reading is continued until the desired amount has been collected.

2. Verify the integrity of the header. The Cookies in the header are for verifying its integrity. TCP Sockets guarantee correct delivery from end to end therefore this integrity checking is done only for the sake of verifying programming correctness and it also is a simple first pass mechanism for eliminating “Rogue” connections.

3. Verify the Protocol ID and version (This is to allow for future variations)

4. Receive the data based upon the size indicated in the header

5. Decrypt the data if need be based upon the DATA_ENCRYPTED flag bit in the FlagBits member of the header

When sending a message the following must be done:

1. Create the basic Transmission header

2. Based upon the command of the Application layer, encrypt the data if need be and set the DATA_ENCRYPTED bit in the FlagBits member of the header

3. Set the MessageSize field in the header indicating the length of the data

4. Set the Cookies in the header

5. Set the Protocol ID and version (This is to allow for future variations)

6. Send the header

7. Send the data

The Session layer does not support “log-out” but rather a connection is released by simply closing the socket connection.

The Session layer timeouts vary depending on the connection medium. Direct phone connections are quite fast and reasonably predictable, while Internet connections can run into significant and unpredictable delays. As an estimate, 50-second timeouts are uses for phone connections and 140 seconds are used for Internet connections.

The following describes the common errors and how to handle them:

Error: Connection to server can't be established within the timeout period.

Action: Try again for several times before giving up.

Error: Transmission header or data is not sent or received properly.

Action: Release the connection by closing the socket thereby terminating the session. It is up to the application layer to try again.

The services and Internet server 50 is designed to run on any Win32 platform, i.e., Windows-95, Windows-98 and Windows NT.

It is preferably a multi-threaded server, which uses the ATL free threading model. It provides the communication between Front End Server (FES) and PSD Agent through modem or Internet. The PSD Agent will create the instance of the object, which launches the Server. The Server is implemented as a process (exe) server because it is placed on the machine that can connect to the FES via Internet or Modem. It keeps the counter of the number of open connections. When it reaches zero, it gets disconnected from the FES.

The public interfaces can be found in the server component's IDL file (AGServer.IDL). Operation is as follows.

The Client will request for the “OpenConnection” for TMS or KMS. Client will wait until it timeout or connected successfully to FES. If the open connection fails through one of the method (Modem or Internet) then it will try another method. If both of them fail then it will return the error code to the client. On successful connection to the FES, it will increment the counter of the m_nConnection of the CAGServerModule. Therefore, for the next OpenConnection request it does not have to dial again. It can use already established communication link. In addition, it will go through all Waiting Object and Set all of them, which will release all WaitForOpenConnection requests.

“CloseConnection” will be called once the necessary Send and Receive Message process is received. It will decrement the counter of m_nConnection by one.

“SendMessageSync” will wait until it gets acknowledgement or timeout takes place. “SendMessageAsync” will return promptly. It will send the size of the message buffer and message buffer pointer.

“ReceiveMessage” will wait for the data. It will return on the receiving of the data or timeout. CSocketMgr is going to maintain the queue for the received messages. The parameter for the ReceiveMessage is the pointer for the size of the message buffer and pointer to the messages buffer pointer.

“WaitForOpenConnection” checks whether connection to FES is already open. If it is open it then returns with success promptly else resets the event object and waits for the event object to be set.

In “ReleaseWaitForOC”, SetEvent on the event object. It will release the Locked thread created by WaitForOpenConnection.

All of the above API will return HRESULT. The result of the operation will be given in the StatusPtr passing parameter.

The following registry variables are available for debugging and setting server properties:

TraceLevel1, . . . , TraceLevel5

Turn on/off event log traces.

ServiceList—

List of the Service Supported such as “TMS, KMS” CommunicationPreference—

0//First preference will be for Modem

1//First preference will be for Internet

CommunicationMethods—

0//Modem Only

1//Internet Only

2//Either of one

Depending upon the registry settings CommunicationPreference and CommunicationMethods, the server will decide how to be connected with the FES. If the CommunicationMethods allows only modem connection, then it will try to be connected through modem only and vice versa. However, if it allows both methods, then it will look for the value of CommunicationPreference and it will decide how to be connected with the FES.

InternetConnectionTimeout—ConnectionTimeout if Connected through Internet.

ModemConnectionTimeout—ConnectionTimeout if Connected through Modem.

DialUpScript—

When Dialed through modem. Send this Script to Dialup adapter to dial out.

Service Related Settings (Each Service such as TMS, KMS has its own settings as follows)

IPAdr—Where the particular service related Services Router is located (FES)

PortAdr—With which Port to talk

ModemTimeoutSec—If connected through Modem what will be the timeout.

InternetTimeoutSec—If connected through Internet what will be the timeout.

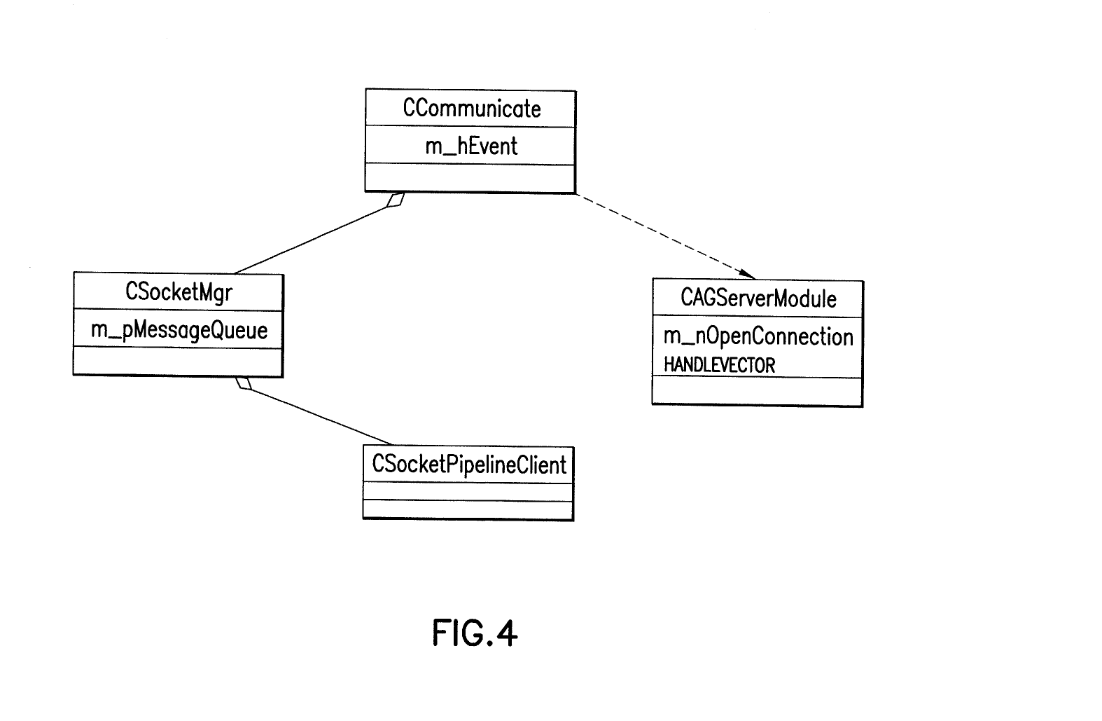

The server gateway is comprised of the classes depicted in FIG. 4.

CCommunicate: Class Header File: Communicate.h

This is the server's COM class. It is a free threaded COM object, which provides the methods to connection to FES, Send/Receive data and Wait and Release for open connection. The member variable m_hEvent is the Event object used for the synchronization purpose. The data member m_hEvent will be created in the constructor of the CCommunicate. In addition, it will be copied into the HANDLEVECTOR maintained by CAGServerModule.

CAGServerModule: Module File: Agserver.cpp

This is the COM Server's exe class. The common Server data and methods are placed in COM's static global class CAGServer named _Module. The data member m_nOpenConnection will keep the track of the number of open connections. When it reaches zero. It will break the connection between FES and server.

CsocketMgr: Class Header File: SocketMgr.h

This is the Ascom Gateway Server's class. This class makes the socket connection with the FES via Modem or Internet. It manages the message receive queue for the responses it is going to get from the FES. In addition, it will have callback function, which will get status of the send messages and received data. Received data will be managed inside the m_pMessageQueue.

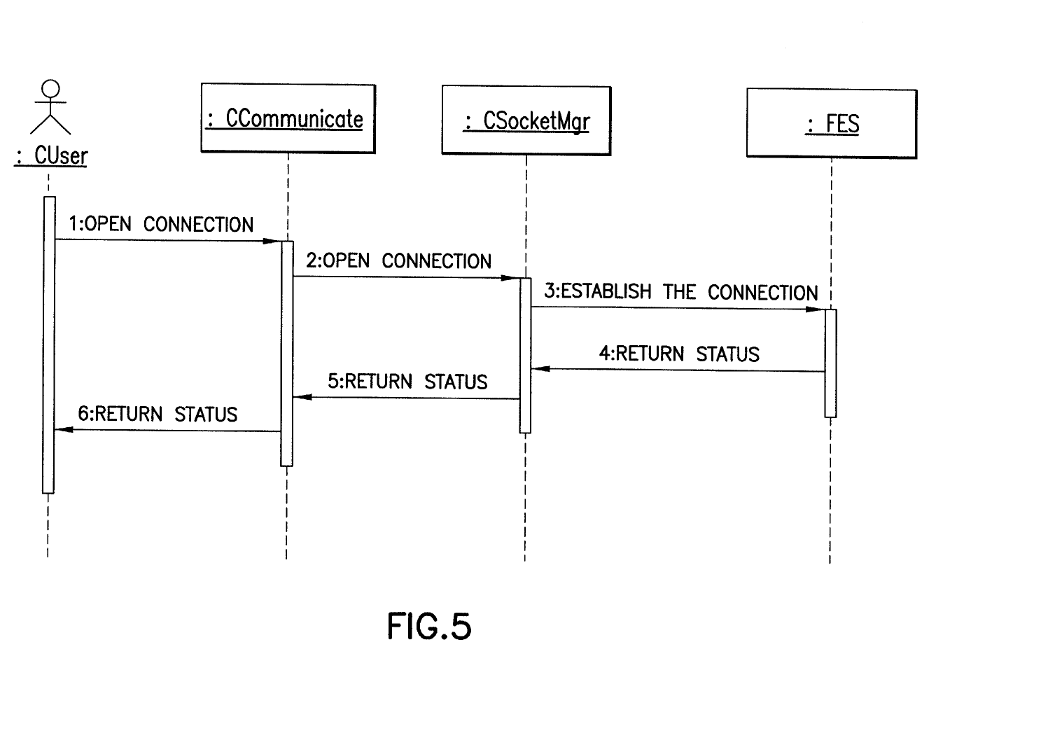

FIG. 5 shows the primary data flows for the server.

Open Connection Request from the User.

FIG. 5 shows a typical data flow for an OpenConnection request from the User to the FES. Other request like CloseConnection, SendMessage, ReceiveMessage are going to use nearly the same sequence.

Startup/Shutdown: The Server is launched by the PSD Agent Server's CoCreateInstantanceEx ( ) for an COM object. The Server's main thread then initiates any common internal processing by calling the Startup ( ) method in _Module.

The Server automatically shuts down when the last COM object is released. The Server's main thread will call the Shutdown ( ) method in _Module to disconnect from the FES.

All the errors regarding the connection and data transfer are displayed to the user with detail description and possible recovery solution. In addition, errors are logged into the event log for future reference.

Services Router (SR) Software Component

The SR acts as a firewall and router for the various systems within the infrastructure which provides some sort of service to products in the field.

The following list provides the functional requirements for the SR:

1. The SR is designed in such a fashion as to remain running on an indefinite basis.

2. The SR shall provide support for multiple Socket ports to be routed. The routing configuration information is to be maintained in the system Registry.

3. The SR maintains and displays statistics on the connection times of clients.

4. The SR shall run on a Windows-NT-Server and may therefore take advantage of its functionality.

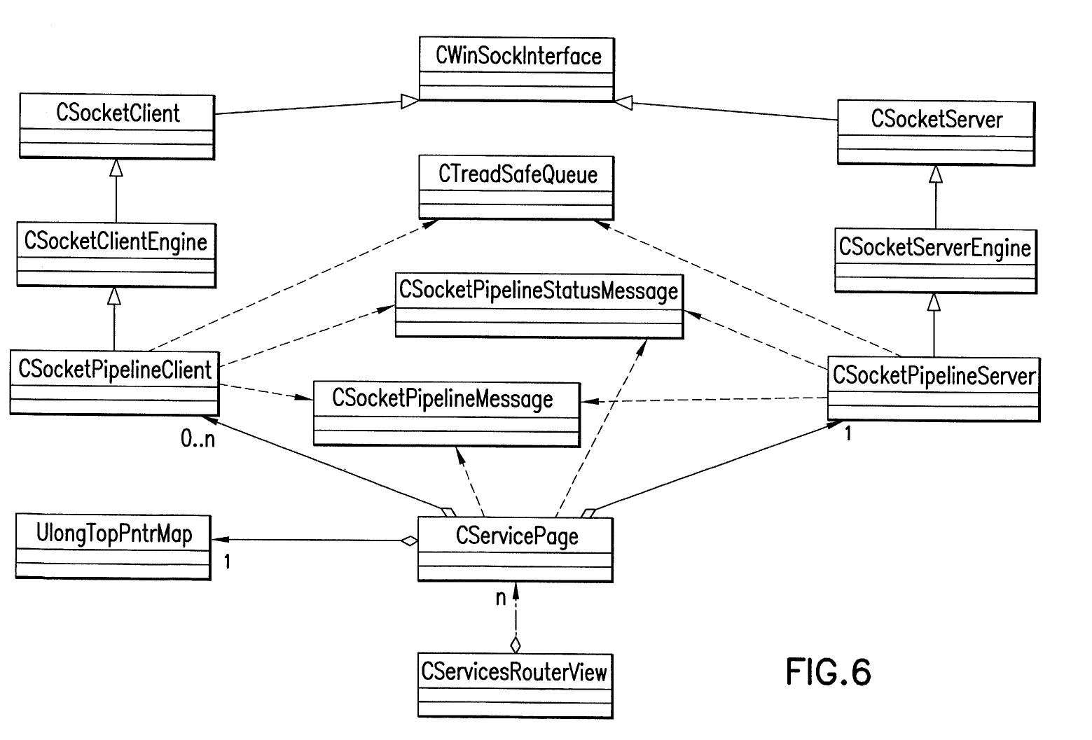

FIG. 6 depicts the classes that comprise the SR. the are set forth below:

CServicesRouterView. The view class of the SR is derived from CFormView and is used as the container for the dialog. There is one dialog displayed which contains a CPropertySheet. When the view is created, it reads the Registry to determine which services it is to route to which servers. It will then create a tab for each service. The tab contains a property page (CServicePage) described below.

CServicePage. This class provides the property page for each tab of the property sheet. It is also the container for the CSocketPipelineServer object whose job it is to receive connections from Socket Clients. When Clients connect, the CServicePage object creates a CSocketPipelineClient object by which it connects to the host providing a service. Subsequently, any messages that are received from the Client are routed to the service host via the CSocketPipelineClient object. Any messages that are received from the Service host via the CSocketPipelineClient object are sent to the Client via the CSocketPipelineServer object.

While there is only one CSocketPipelineServer object, it does handle multiple client connections. However, to connect to the host which provides the service, one CSocketPipelineClient object is created. In order to keep track of all the connections, the CServicePage object uses a map to keep track of this information.

CSocketPipelineServer. This class provides a complete, asynchronous message delivery mechanism for connecting Socket Clients. When this object is created the client code may specify the maximum number of clients that may be accepted. Messages are delivered to and received from the CSocketPipelineServer via the CSocketPipelineMessage object. Messages to be sent out may be sent at will because they will be internally queued. Once a message has been successfully sent, then the client code will be notified with a status message. If the “pipeline” broke and the message was not sent successfully then the client code is also informed.

CsocketPipelineClient. This class provides a complete, asynchronous message delivery mechanism for connecting with a Socket Servers. Messages are delivered to and received from the CSocketPipelineClient via the CSocketPipelineMessage object. Messages to be sent out may be sent at will because they will be internally queued. Once a message has been successfully sent, then the client code will be notified with a status message. If the “pipeline” broke and the message was not sent successfully then the client code is also informed.

CSocketServerEngine. This class provides basic threading mechanisms for accepting Socket Client connections, sending messages and receiving messages.

CSocketClientEngine. This class provides basic threading mechanisms for connecting to a Socket Server, sending messages and receiving messages.

CSocketServer. This class provides basic primitive functions for a Socket Server.

CSocketClient. This class provides basic primitive functions for a Socket Client.

CwinSockInterface. This class provides basic primitive functions for interfacing with the WinSock DLL.

CSocketPipelineMessage. This class defines a basic container object for messages being sent and received.

CSocketPipelineStatusMessage. This class is a container for receiving status from the CSocketPipelineServer or CSocketPipelineClient objects.

CThreadSafeQueue. This class is a thread safe queuing class allowing the passing of objects between threads.

CUlongToPntrMap. A thread safe utility class that stores pointers to anything. The pointers can be retrieved via a Unsigned long value.

CRegistryUtility. A utility class for accessing the registry.

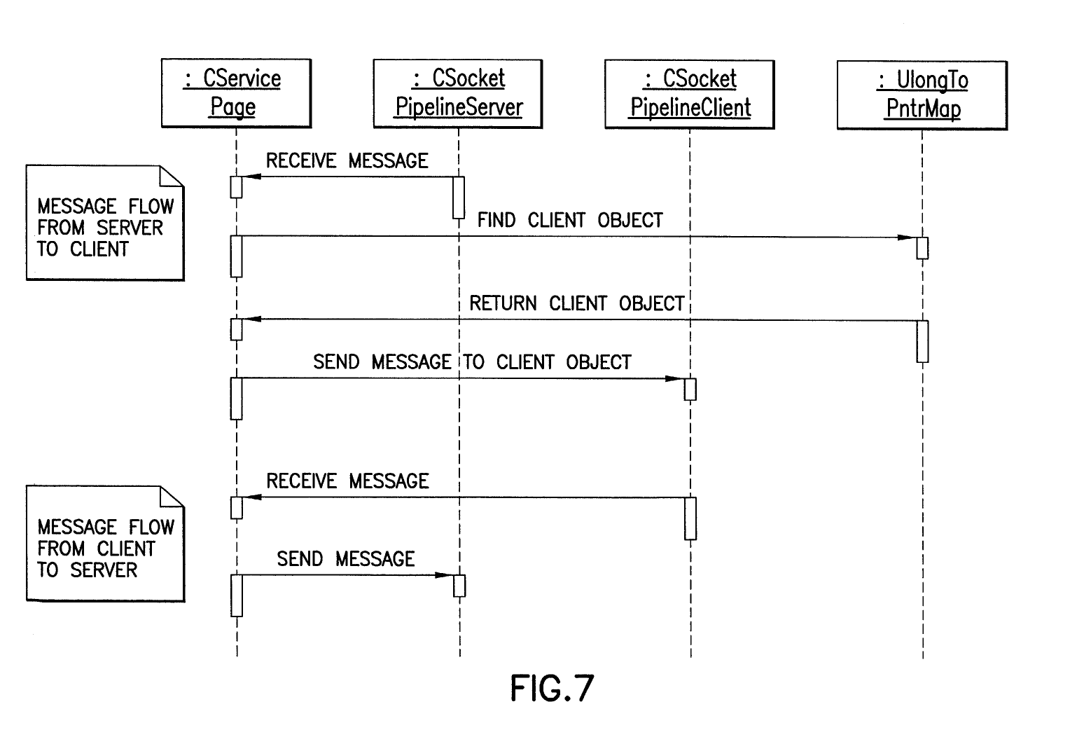

FIG. 7 illustrates the normal flow of both, messages as they arrive from the client and are sent to the server, and messages as they arrive from the server and are sent to the client.

Startup. During startup, the registry is read to determine which services need routing. For each service, the registry will contain Service Host and port information which will ultimately be used by the CSocketPipelineServer and CSocketPipelineClient objects. For each service that is defined, a property page object is created in the property sheet and initialized with the routing information.

Shutdown. When the application is being shut down, the individual property pages are destroyed. As part of the destruction, the Client and Server objects are destroyed as well, implying that the Socket connections will be broken at that time.

Expected errors are those resulting from Socket breakage. These errors are programmatically handled to gracefully clean up the rest of the connection to the Server or Client as appropriate.

Unexpected errors are logged to the Event Logger.

The following describes the messages that are passed between IBIP Open Systems PC Meter USPS Server (Host) and a Log Management System (LMS) associated with PSS 56 (FIG. 2) to upload PSD logs to the entity with responsibility for the infrastructure 24, such as a postal equipment manufacturer.

The USPS currently requires PSD Indicia Logs to be uploaded to a manufacture's infrastructure with every connection. The manufacturer may also keeps a Summary Log which contains PSD usage information. A record contains the PSD's postal serial number, total postage, piece count by date and rate category. The Host creates one PSD Log and one Summary Log for all PSD's configured in the system.

The USPS may drop the requirement for the Indicia Log. However, the manufacturer may continue and may even expand the use of the Summary Log. Therefore the Indicia Log, if upload may be disabled, will be truncated automatically once summary records have been created.

A common message header is used for messages between the Host and LMS as shown below.

| Variable | | Data | |
|---|---|---|---|
| Name | Description | Type | Valid Values |
| MessageID | Identifies the | short | 1 to n |
| | message | | |
| MessageLength | Length of the | long | 0 to n |
| | following | | |
| | message data | | |
| | in bytes | | |
| MessageData | The actual | BYTE | An array of bytes |
| | message data | [ ] | containing the |
| | | | message |
| | | | information |

The messages are described in the following section. The messages consist of a Host login to the LMS, a LMS logout message to terminate the connection with the Host, and a set of LMS commands and Host responses to upload and manage the Host's PSD logs.

Login to LMS. The Host sends a login to the LMS specifying the number of indicia records available for upload. The LMS accepts the login and begins uploading commands, or rejects it and terminates the connection.

| | |
|---|---|
| Message: | LoginForPsdLogs |
| Function: | The login message identifies the |
| | Host's PSDs and their Indicia Log |
| | file sizes. |
| Source System: | Host |
| Target System: | LMS |
| Data Definition: | Message Length: variable length. |

| Variable | | Data | |
|---|---|---|---|
| Name | Description | Type | Valid Values |
| RecordCount | Number of | long | 1 to n |
| | records in the | | |
| | Indicia Log | | |

| | |
|---|---|
| Message: | LoginForPsdLogsResponse |
| Function: | The LMS either accepts the Host |
| | login, which places the Host in a |
| | wait state for an LMS command, or |
| | rejects the Host login, which |
| | terminates the connection. |
| Source System: | LMS |
| Target System: | Host |
| Data Definition: | Message Length: 2 bytes. |

| Variable | | Data | |
|---|---|---|---|
| Name | Description | Type | Valid Values |
| LogonAccepted | LMS informs | short | 1 = accepted, 0 = |
| | Host that | | rejected |
| | Login is | | |
| | accepted. | | |

Logout Host. The LMS ends a Host connection by sending the Logout command. Both the LMS and Host terminate the connection. There is no Host reply message.

| | |
|---|---|
| Message: | Logout |
| Function: | The LMS sends the Logout message to |
| | the Host to terminate the connection. |
| Source System: | LMS |
| Target System: | Host |
| Data Definition: | None. |

Upload Indicia Log. The LMS begins an Indicia Log upload by sending the SendIndiciaLog command. The Host sends SendIndiciaLogResponse messages until the file has been transmitted.

| | |
|---|---|
| Message: | UploadIndiciaLog |
| Function: | An upload request by the LMS for a |
| | PSD's Indicia Log. |
| Source System: | LMS |
| Target System: | Host |
| Data Definition: | None. |
| Message: | UploadIndiciaLogResponse |
| Function: | Each response contains an end-of-file |
| | flag and one or more fixed length |
| | Indicia Log records. The maximum |
| | message data size is 512 bytes. |
| | Messages are sent till end-of-file. |
| Source System: | Host |
| Target System: | LMS |
| Data Definition: | Message Length—variable length |
| (maximum 5K). | |

| Variable | | Data | |
|---|---|---|---|
| Name | Description | Type | Valid Values |
| EndOfFile | End of Indicia | short | 1 = eof, 0 = more |
| | Log. | | records exist |
| NumberOfRecords | Number of | short | 0 to n |
| | Indicia Log | | |
| | records in | | |
| | this message. | | |
| RecordData | One or more | Indicia | Indicia records |
| | fixed length | Record | |
| | Indicia Log | structure | |
| | records. | | |

Upload Summary Log. The LMS begins a Summary Log upload by sending the SendSummaryLog command. The Host sends SendSummaryLogResponse messages until the file has been transmitted.

| | |
|---|---|
| Message: | UploadSummaryLog |
| Function: | An upload request by the LMS for a |
| | PSD's Summary Log. |
| Source System: | LMS |
| Target System: | Host |
| Data Definition: | None. |
| Message: | UploadSummaryLogResponse |
| Function: | Each response contains an end-of-file |
| | flag and one or more fixed length |
| | Summary Log records. The maximum |
| | message data size will be 512 bytes. |
| | Messages are sent till end-of-file. |
| Source System: | Host |
| Target System: | LMS |
| Data Definition: | Message Length—variable length |
| (maximum 5K). | |

| Variable | | Data | |
|---|---|---|---|
| Name | Description | Type | Valid Values |
| EndOfFile | End of Summary | short | 1 = eof, 0 = |
| | Log. | | more records |
| | | | exist |
| NumberOfRecords | Number of | short | 0 to n |
| | Summary Log | | |
| | records in | | |
| | this message. | | |
| RecordData | One or more | Summary | Summary records |
| | fixed length | Record | |
| | Summary Log | structure | |
| | records. | | |

Set Logging. The LMS controls the Host's PSD Indicia logging by sending the SetLogging command. Logging is turned on or off for all PSD Indicia Logs.

| | |
|---|---|
| Message: | SetLogging |
| Function: | A LMS command to start/stop all PSD |
| | Indicia logging. |
| Source System: | LMS |
| Target System: | Host |
| Data Definition: | Message Length—2 bytes. |

| Variable | | Data | |
|---|---|---|---|
| Name | Description | Type | Valid Values |
| SetLoggingOn | Turns logging | short | 1 = on, 0 = off |
| | on or off for | | |
| | all PSDs on | | |
| | the Host. | | |

| | |
|---|---|
| Message: | SetLoggingResponse |
| Function: | The Host informs the LMS of the new |
| | logging state. |
| Source System: | Host |
| Target System: | LMS |
| Data Definition: | Message Length—2 bytes. |

| Variable | | Data | |
|---|---|---|---|
| Name | Description | Type | Valid Values |
| LoggingSetOn | The current | short | 1 = on, 0 = off |
| | Host's logging | | |
| | state. | | |

Clear PSD Log. The LMS clears the Host's local logs by sending the ClearPsdLog command.

| | |
|---|---|
| Message: | ClearPsdLog |
| Function: | A LMS command to clear all logs for a |
| | PSD. |
| Source System: | LMS |
| Target System: | Host |
| Data Definition: | None. |
| Message: | ClearPsdLogResponse |
| Function: | The Host informs the LMS the result |
| | of the ClearPsdLog command. |
| Source System: | Host |
| Target System: | LMS |
| Data Definition: | Message Length—2 bytes. |

| Variable | | Data | |
|---|---|---|---|
| Name | Description | Type | Valid Values |
| LogsCleared | Logs for PSD | short | 1 = cleared, 0 = |
| | cleared | | error |

It should be understood that the foregoing description is only illustrative of the invention. Various alternatives and modifications can be devised by those skilled in the art without departing from the invention. For example, while not shown, it is possible to provide a series of services other than postal services to the remote stations as described above. These may include, for example, the printing of tickets to entertainment events or lottery tickets. In addition, other postal services such as account management or address cleansing may be provided by infrastructure 14 to remote stations 16. Accordingly, the present invention is intended to embrace all such alternatives, modifications and variances which fall within the scope of the appended claims.

What is claimed is:

1. A system for providing postal services to a plurality of remote postal printing stations, said system comprising:
a communications facility for conducting communications between said system and said remote postal printing stations; and
a plurality of services provided by said system to said remote stations when said remote stations access said system using said communications facility.

2. The system of claim 1, wherein said services include at least one selected from the group consisting of:
a key management system;
a funds telemetering system;
a software updating system;
a postal rate updating system;
an address cleansing system;
a postal account management system; and
a postal statistics server system.

3. The system of claim 2, further comprising facilities for providing services other than postal services.

4. The system of claim 3 wherein said services other than postal services include at least one of printing tickets to entertainment events and printing lottery tickets.

5. The system of claim 1, wherein said communications facility includes an interface for Internet communication and an interface for modem communication.

6. The system of claim 1, wherein said interface for internet communication includes a remote access server and a plurality of application programming interfaces.

7. The system of claim 1, further comprising a monitor for determining when any service is being accessed, said monitor providing a signal to all other services that a service can be provided to said remote station.

8. The system of claim 1, in combination with at least one of said plurality of remote postal printing stations.

9. The system of claim 8, wherein each of said postal printing stations has a monitor for determining when any service is being accessed, said monitor providing a signal to all other services that a service can be provided to said remote station.

10. The system of claim 1, further comprising data encryption facilities, a different level of security being provided by said facilities for different ones of said services.

11. A method of operating a system for providing postal services to a plurality of remote postal printing stations, said method comprising:
using a communications facility for conducting communications between said system and said remote postal printing stations; and
using a plurality of services provided by said system to said remote stations when said remote stations access said system using said communications facility.

12. The method of claim 11, wherein said services include at least one selected from the group consisting of:
a key management process;
a funds telemetering process;
a software updating process;
a postal rate updating process;
an address cleansing process;
a postal account management process; and
a postal statistics acquisition process.

13. The method of claim 12, wherein said system includes additional facilities for providing services other than postal services further comprising using said additional facilities for providing services other than postal services.

14. The method of claim 13 wherein said services other than postal services include at least one of printing tickets to entertainment events and printing lottery tickets.

15. The method of claim 11, wherein said communications facility includes an interface for Internet communication and an interface for modem communication, further comprising using at least one of said interfaces for communication.

16. The method of claim 15, wherein one of said interfaces is a default interface which is used first to attempt to establish communications and the other of said interfaces is a backup interface, used if said default system fails to establish communications.

17. The method of claim 11, wherein said interface for internet communication includes a remote access server and a plurality of application programming interfaces, further comprising using at least two of said application programming interfaces when communications have been established.

18. The method of claim 17, comprising using said plurality of application programming interfaces simultaneously.

19. The method of claim 11, further comprising:
using a monitor for determining when any service is being accessed, said monitor providing a signal to all other services that a service can be provided to said remote station; and
activating other services when the signal is received.

20. The method of claim 11, further comprising printing postage with at least one of said plurality of remote postal printing stations.

21. The method of claim 20, wherein each of said postal printing stations has a monitor for determining when any service is being accessed, said monitor providing a signal to all other services that a service can be provided to said remote station, further comprising activating other services when the signal is received.

22. The method of claim 11, wherein said system further comprises data encryption facilities, the method further comprising using a different level of security for different ones of said services.
